(19) United States
(12) Patent Application Publication
(10) Pub. No.: US 2010/0101205 A1
(43) Pub. Date: Apr. 29, 2010

(54) DEVICE FOR DEFLECTION AND RETENTION OF AIRCRAFT ENGINE DEBRIS

(75) Inventors: Gilles Weyland, Brax (FR); Bernadette Dulay, Dulay (FR); David Hardy, Merenvielle (FR)

Correspondence Address: YOUNG & THOMPSON, 209 Madison Street, Suite 500, Alexandria, VA, 22314, US

(73) Assignee: AIRBUS FRANCE, Toulouse (FR)

(21) Appl. No.: 12/594,055

(22) PCT Filed: Mar. 28, 2008
(86) PCT No.: PCT/FR08/50557

§ 371 Date: Sep. 30, 2009

(30) Foreign Application Priority Data
Mar. 30, 2007 (FR) 0754160

(51) Int. Cl. F02C 7/00

(52) U.S. Cl. 60/39.091

(57) ABSTRACT

A protective device for treating at least one piece of debris that comes from a source of an aircraft, in particular a compressor stage or a turbine stage of an aircraft power plant, and to prevent it from reaching a target of the aircraft, characterized in that it has a geometry and a position relative to the source and to the target that make it possible to deflect the debris with the most energy so as to protect the target that is placed in a predefined protected zone.

This invention relates to a device for deflection and retention of debris that originates from an aircraft power plant, and more particularly debris that comes from a compressor stage or turbine stage of the power plant.

In terms of protection, a first solution consists in protecting certain elements called target elements by placing a screen or a strong structure between the potential source of debris and the target element that is close to said element. The screen should be able to retain the elements with the most energy.

According to another solution, the essential elements as well as the control circuits of an aircraft are generally segregated to offer more safety. By way of example, an aircraft contains several hydraulic and electrical circuits to ensure the same function, such that the loss of one of these circuits (control or power circuit) would not cause a loss of function itself. This widely used solution leads to increasing the on-board weight and to complicating the design of the power plant, in particular by avoiding the juxtaposition of primary elements and corresponding safety systems.

According to another approach, the solutions aim at treating the debris source(s) or the debris itself.

At the power plant, there are essentially two debris sources, namely the fan from which blades or pieces of blades can become detached and the turboreactor from which stages or portions of compressor stages or turbine stages can become detached.

Relative to the fan, one solution consists in providing a belt whose purpose is to retain the debris on the periphery of the fan. Thus, the debris is confined to the inside of the belt and cannot reach the targets.

According to this solution, the characteristics of the belts, in particular the dimensions and the materials, are determined so as to retain the debris with the most energy. Whereby the installation zone of the belt is not very stressed in terms of temperature, it is possible to use composite elements and/or an alveolar structure so as not to increase the on-board weight too much.

Finally, the continuous shape of the belt makes it possible both to contain a fragment regardless of its ejection angle and to obtain a greater mechanical strength than from separate elements.

Relative to the turboreactor, the motorists tend to make the engine elements more reliable so as to reduce the risks of the elements that constitute said element breaking, in particular rotary elements such as the stages of compressors or turbines. This solution leads to increasing the safety coefficients during the design of the pieces, to the improvement of the materials, and to providing processes for production of the pieces that integrate more numerous and/or more exhaustive quality controls. Even if this solution makes it possible to reduce the risks of breakdown, it does not cancel them totally although there is always a risk that one of the elements of the stages of the compressors and turbines will become detached and damage a portion of the aircraft.

One solution could consist in using a belt such as for the fan. This solution, however, is not easily conceivable in particular to the extent where the implantation zone is more greatly stressed in terms of temperature.

According to a solution that is described in the document U.S. Pat. No. 3,974,313, it is possible to provide a point-type treatment, namely on a non-circumferential limited zone. According to this document, the protective device comprises a deformable panel that can retain the ejected debris. To retain the debris, the energy from the debris is to be totally absorbed using the deformation of the protective panel. This solution can be hard to implement to retain the debris with the most energy.

Also, to limit the harmful effects of an engine explosion, the aircraft manufacturers use several solutions whose purpose is essentially to segregate the systems to make them more tolerant, to hide the systems behind the strong structures, to limit the structural consequences by creating paths for residual stress after impact, for example, in a manner that is very well controlled by the aeronautical regulations and by considering in general an infinite energy for the debris.

Also, the purpose of this invention is to eliminate the drawbacks of the prior art by proposing a device for deflection and retention of debris from an aircraft power plant whose purpose is to make the architecture selections more flexible by keeping the objective of making the aircraft more reliable, while not increasing the on-board weight excessively.

For this purpose, the invention has as its object a protective device for treating at least one piece of debris that originates form a source of an aircraft, in particular a compressor stage or a turbine stage of an aircraft power plant, and to prevent it from reaching a target of said aircraft, characterized in that it has a geometry and a position relative to the source and the target that make it possible to deflect the debris with the most energy so as to protect said target that is located in a predefined protected zone.

Other characteristics and advantages will emerge from the following description of the invention, a description that is provided only by way of example, relative to the accompanying drawings in which:

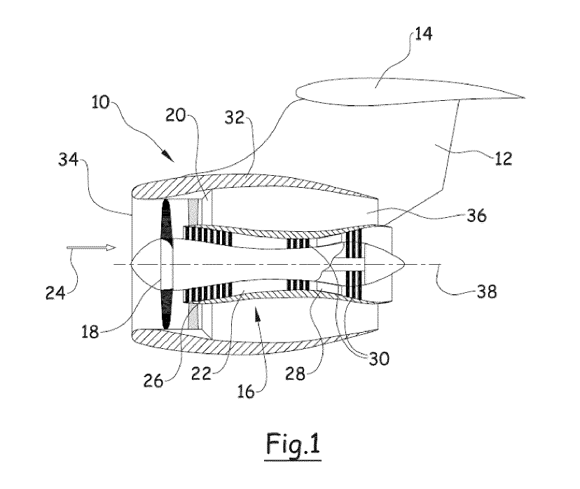

FIG. 1 is a longitudinal cutaway of a propulsion system of an aircraft,

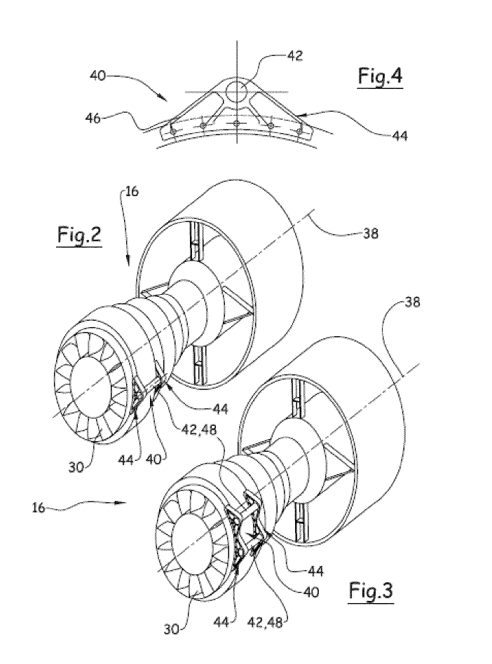

FIG. 2 is a perspective view of a power plant that is equipped with a device according to a first variant of the invention,

FIG. 3 is a perspective view of a power plant that is equipped with a device according to another variant of the invention,

FIG. 4 is a side view that affords a detailed illustration of the attachment means of the device of FIG. 2,

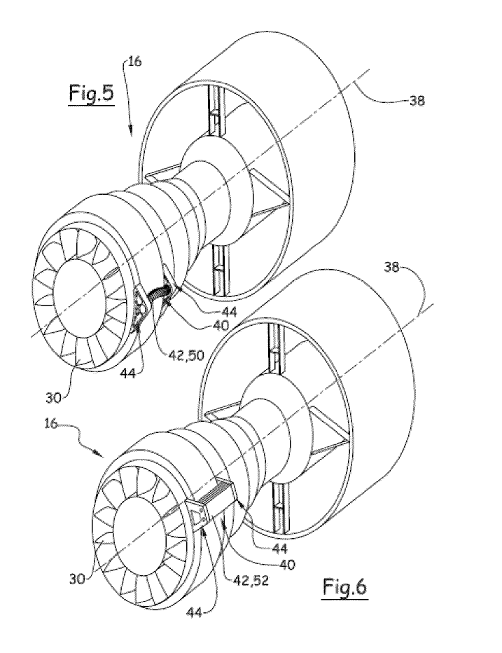

FIG. 5 is a perspective view of a power plant that is equipped with a device according to another variant of the invention,

FIG. 6 is a perspective view of a power plant that is equipped with a device according to another variant of the invention,

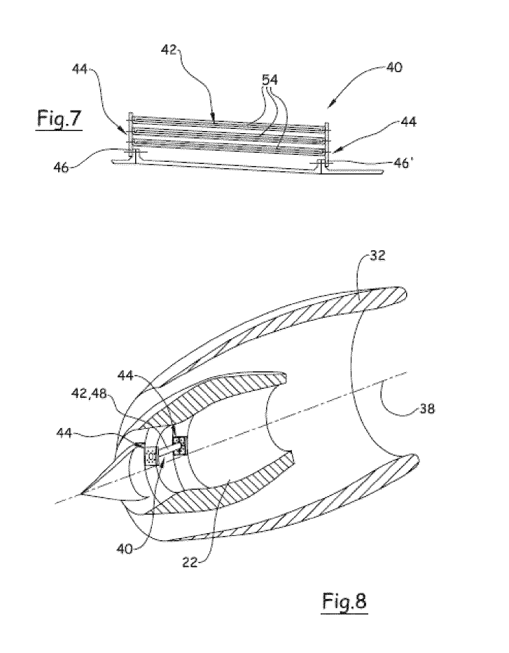

FIG. 7 is a side view that affords a detailed illustration of another variant of the device of the invention,

FIG. 8 is a diagram that illustrates another implantation zone of a device according to the invention,

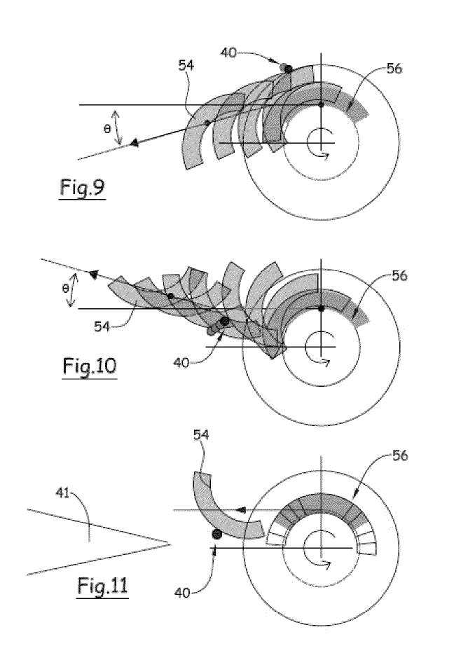

FIG. 9 is a diagram that illustrates the deflection of a piece of debris in a first direction using a device of the invention,

FIG. 10 is a diagram that illustrates the deflection of a piece of debris in another direction using a device of the invention, and

FIG. 11 is a diagram that illustrates a zone that is protected by a device according to the invention.

FIG. 1 shows a propulsion system 10 of an aircraft, also called a turboreactor, connected—using connecting means—to an aircraft, in particular using a mast 12 under an aircraft wing 14. It comprises an engine 16 with, on the one hand, a fan that comprises a rotor 18 that is equipped with blades, and a stator 20 that is equipped with paddles, and, on the other hand, a primary pipe 22 into which compressor stages 26, a combustion chamber 28 and turbine stages 30 are placed in the direction of flow of the air 24. The engine 16 is placed in a nacelle 32, which comprises an air intake 34 upstream from the fan and a secondary pipe 36 downstream from the stator of the fan.

As illustrated in the figures, the engine comprises a first part at the front, where the fan is located, and a second part at the rear, where the compression stages, the combustion chamber, as well as the turbine stages are placed, whereby said part has a relatively smaller diameter than the front part and is more greatly stressed in temperature and is subjected to temperatures that are greater than or equal to 300° C.

In terms of protection, a belt can be provided around the fan whose purpose is to hold a blade or a piece of blade that may become detached from the fan. The mechanical characteristics of this belt are determined so as to be able to retain the debris with the most energy.

The compressor stages 26 and the turbine stages 20 come in the form of disks that comprise flanges, able to pivot along the axis of the shaft of the engine 16, embodied by the axis referenced 38.

As for the fan, parts of the moving elements of the engine 16, in particular compressor stages and turbine stages, can become detached or break accidentally and form debris that can damage another part of the aircraft.

Contrary to the debris that comes from the fan and that has random movements, the applicant pointed out, after observations, that the debris that comes from compressor stages and turbine stages in most cases has a particular kinematics; in particular, this debris pivots on itself and has a so-called priority trajectory.

According to the invention, the propulsion system comprises a device 40 in the environment of the engine, not circumferential, whereby said device has a geometry that makes it possible to deflect the debris with the most energy. According to the invention, the device 40 is inserted between a source of debris, in particular the compressor stages 26 and/or the turbine stages 30, and the zone 41 to be protected as illustrated in FIG. 11.

Unlike a belt, the device 40 of the invention does not extend over the entire circumference of the engine at the periphery of the rotary element. Thus, according to the invention, the device 40 is of the point type and occupies a restricted zone.

The device is placed so as to be secant with the priority trajectory. This configuration makes it possible to be able to limit the on-board weight.

Unlike the devices of the prior art, the device 40 of the invention is not designed to retain the debris with the most energy, but its geometry and its position relative to the source of the debris and the target are determined so as to deflect the debris with the most energy, i.e., to absorb only a portion of their energy. This configuration makes it possible to be able to limit the on-board weight.

The protective device preferably has a convex shape so as to promote the deflection of debris and not to retain it.

Advantageously, the device is made from materials that are suitable for withstanding temperatures on the order of 300 to 400° C. or more.

To the extent that the device is of the point-type and designed to deflect the debris with the most energy and not to retain it, it is suitable to use materials that withstand high temperatures, without, however, consequently increasing the on-board weight.

On the one hand, the device 40 comprises at least one deformable part 42, and, on the other hand, connecting means 44 to the engine or to the nacelle, and even to the aircraft. The device comprises a deformable part so as not to break and to constitute debris that is able to damage sensitive zones of the aircraft.

According to variants, the connecting means 44 connect the device of the invention to the engine, in particular with rings provided on the periphery of the engine, as illustrated in FIGS. 2, 3, 5 and 6, or with a fairing that delimits the inside wall of the secondary pipe of the nacelle as illustrated in FIG. 8.

Advantageously, the connecting means 44 absorb a portion of the energy that is produced during the impact of a piece of debris in particular due to the materials that are used for the connecting means and/or to the dimensioning of the connecting means and/or the shapes of the connecting means.

Preferably, the connecting means 44 comprise two fittings 46, 46′ that are afforded detailed illustrations in FIGS. 4 and 7, placed on both sides of at least said deformable part 42, whereby attachment means make it possible to connect each fitting to the aircraft and attachment means make it possible to connect each fitting to at least said deformable part 42.

Advantageously, the deformable part 42 has a geometry that is suitable for promoting the deflection of debris with the most energy and preferably for making it possible for said debris to roll on said part, taking into consideration its shape and its movement of pivoting on itself.

On the surface, at least at the level of the probable impact zone, the deformable part 42 is to have a high shear resistance while preferably having, at the core, a high capacity for deforming.

Advantageously, the deformable part(s) 42 is/are made of a first material that has a high dynamic shear resistance and a second material that has a high capacity for dynamically deforming without breaking,

By way of example, the first material is selected from among the following materials: titanium, high-alloyed steel, such as, for example, a product that is marketed under the trademark INCONEL, composite based on CMC-type ceramic fibers, . . . .

By way of example, the second material is selected from among the following materials: a composite product based on aramid fibers, such as, for example, the product that is marketed under the KEVLAR brand, metal foams, metal honeycomb . . . .

According to a first variant, the deformable part 42 can come in the form of at least one rod 48, for example a single rod as illustrated in FIG. 2, two rods as illustrated in FIG. 3, or a rod mesh.

Advantageously, the rod or rods are arranged in the longitudinal direction, namely parallel to the axis 38.

The rod can have different cross-section shapes, for example circular, triangular, square, etc.

The rod or the rods have two separate effects:
Due to the shape of the section of the rod or rods, the debris, based on its position at the time of impact, will be deflected for configurations where the center of gravity of the debris is offset from that of the rod.
Due to its capacity to deform, the rod will absorb all or part of the kinetic energy of the debris.

According to another embodiment, the deformable part can come in the form of at least one cable 50, for example a single cable 50 as illustrated in FIG. 5 or several cables 50.

The cable has effects that are essentially similar to those of the rod. In addition, it offers the possibility of moving a long way before deforming.

Other forms can be considered, such as, for example, at least one band 52 or a stack of bands 52 as illustrated in FIGS. 6 and 7.

The plate can be more or less tilted to form with the priority trajectory an angle that promotes the deflection of the debris with the most energy. The plate or plates achieve two distinct effects:

It (they) make(s) it possible to deflect the debris with the most energy in particular by being more or less tilted with the priority trajectory of the debris.

The deformable part or parts 42 can consist of a combination of rod(s), cable(s), plate(s): for example, a series of parallel, juxtaposed rods that are combined or offset with a plate, a cable that is inserted in a rod or an absorbent material in a hollow structure such as a rod or a plate stack.

FIGS. 9 and 10 show a piece of debris 54 that comes from a source 56. Based on the direction of rotation of the debris and the relative position of the protective device and the trajectory of the debris, the latter can be deflected as illustrated in FIG. 9 or deflected after having rolled on the device 40 as illustrated in FIG. 10. Thus, as illustrated in FIG. 11, a protective device 40 can protect a sensitive element that is placed in a protected zone 41, whereby the debris is separated from this protected zone using the protective device 40.

As illustrated in FIGS. 9 and 10, it is noted that the device 40 deforms during impact with the debris so as not to break and to constitute a piece of debris that can damage a sensitive element that is placed in the protected zone 41.

Even if it is described as being used for treating the “guilty” element by being placed close to the source of the debris, the device of the invention could be used to treat the “target” element by being placed close to the element to be protected from the debris.

Unlike the prior art, the purpose of the invention is to size the elements not for debris with an infinite energy but for absorbing a portion of the debris with the most energy. In this case, even if the kinetic energy is not totally absorbed, by deflecting the debris and deforming, the device makes it possible to absorb a significant portion of the energy of the debris with the most energy so that even if it is not retained, the remaining energy is greatly reduced, making said debris less offensive.

1. Protective device for treating at least one piece of debris (54) that comes from a source (56) of an aircraft, in particular a compressor stage or a turbine stage of an aircraft power plant, and to prevent it from reaching a target of said aircraft, characterized in that it has a geometry and a position relative to the source (54) and to the target that make it possible to deflect the debris (54) with the most energy so as to protect said target that is placed in a predefined protected zone (41).

2. Protective device according to claim 1, wherein it is made from materials that are suitable for withstanding temperatures on the order of 300° C. or more.

3. Protective device according to claim 1, wherein it comprises, on the one hand, at least one deformable part (42), and, on the other hand, connecting means (44) to the aircraft.

4. Protective device according to claim 3, wherein said at least one deformable part (42) is made of a first material that has a high dynamic shear resistance and a second material that has a high capacity for dynamically deforming without breaking.

5. Protective device according to claim 1, wherein the deformable part (42) comprises at least one rod (48).

6. Protective device according to claim 1, wherein the deformable part (42) comprises at least one cable (50).

7. Protective device according to claim 2, wherein it comprises, on the one hand, at least one deformable part (42), and, on the other hand, connecting means (44) to the aircraft.

8. Protective device according to claim 2, wherein the deformable part (42) comprises at least one rod (48).

9. Protective device according to claim 3, wherein the deformable part (42) comprises at least one rod (48).

10. Protective device according to claim 4, wherein the deformable part (42) comprises at least one rod (48).

11. Protective device according to claim 2, wherein the deformable part (42) comprises at least one cable (50).

12. Protective device according to claim 3, wherein the deformable part (42) comprises at least one cable (50).

13. Protective device according to claim 4, wherein the deformable part (42) comprises at least one cable (50).

14. Protective device according to claim 5, wherein the deformable part (42) comprises at least one cable (50).
